(19) United States
(12) Patent Application Publication
(10) Pub. No.: US 2008/0030083 A1
(43) Pub. Date: Feb. 7, 2008

(54) HAND-GUIDED POWER TOOL AND COUPLING OF A HAND-GUIDED POWER TOOL

(76) Inventors: Ulrich Mueller-Boysen, Esslingen (DE); Florian Bantle, Ebersbach/Fils (DE)

Correspondence Address: Striker, Striker & Stenby, 103 East Neck Road, Huntington, NY, 11743, US

(21) Appl. No.: 11/830,040

(22) Filed: Jul. 30, 2007

(30) Foreign Application Priority Data
Aug. 3, 2006 (DE) 102006036634.4

(51) Int. Cl. H02K 7/14

(52) U.S. Cl. 310/50

(57) ABSTRACT

A hand-guided power tool, particularly grass clippers, includes at least one rod holder and tool holder and a guide rod connected with the rod holder. A coupling is provided between the tool holder and the rod holder and has a swivel guide that permits the tool holder and the rod holder to rotate relative to each other.

### CROSS-REFERENCE TO A RELATED APPLICATION

The invention described and claimed hereinbelow is also described in German Patent Application DE 102006036634.4 filed on Aug. 3, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a hand-guided power tool and a coupling of a hand-guided power tool.

Working with hand-guided power tools can be simplified to a certain extent by designing a tool holder to be pivotable. The ability to swivel the tool is useful, e.g., when cutting difficult-to-reach branches or when trimming hedges. With grass clippers, it can be advantageous to swivel a cutting head around a device central axis in order to trim the edges of a lawn.

According to the related art, it is known to lock a manual rotating mechanism required to perform the swivel motion described in position using a crown joint, which can be located on a free end of a guide rod which is connectable with the device. A “guide rod” is basically understood to mean an additional handle that is used, e.g., in combination with grass clippers. When the grass clippers are attached, the operator is able to cut the grass on uneven ground while standing up. An angle of the rotating mechanism can be adjusted with a guide rod of this type by removing the guide rod from the device, rotating it, and re-inserting it. It is also known to secure the locked position using a detent knob, to prevent the guide rod from accidentally coming loose. The swivel mechanism of the tool holder with a device of this type is relatively complicated to operate.

A guide rod of this type can be used with or without rollers. If wheels are used in combination with a guide rod, they can be clipped onto a device together with the guide rod. The disadvantage is that it is not possible to rotate a tool holder.

With another hand-guided power tool, it is known to clip on wheels and connect a guide rod with the device. A tool of the device, e.g., a cutting head, can be loosened by releasing a sliding locking device, and rotating it by an angle of +/−90°. The need to perform the additional step of operating a sliding device of this type is relatively complicated.

### SUMMARY OF THE INVENTION

An inventive hand-guided power tool is based on a rod holder, a guide rod capable of being connected with the rod holder, and a tool holder. It is provided that a coupling is provided between the tool holder and the rod holder; the coupling has a swivel guide that allows the tool holder and the rod holder to rotate relative to each other. An inventive coupling of a hand-guided power tool includes at least one base element and a locking element, each of which includes at least one guide groove.

Advantageously, an easily operated swivel mechanism is attained with the proposed solution, it being possible to trigger the swivel mechanism without actuating a button, a switch, or the like. Favorably, the tool holder is connected with the coupling such that it can form a pivotable unit together with the coupling. The tool located in the tool holder, e.g., clippers or another cutting device, is favorably swiveled together with the pivotable unit.

In a preferred embodiment, the coupling is formed out of a plate-shaped base element, at the least. At least one guide groove, which is engaged with a corresponding peg on the rod holder, can be provided as the swivel guide for the coupling. Favorably, the rod holder includes—on its end face—two axially extending pegs, which engage in the coupling; one of the pegs is guidable in the guide groove, and the tool holder connected with the coupling is capable of being pivoted around the other peg as the axis of rotation.

To enable an advantageous swiveling of the pivotable unit in two directions, two longitudinal guide grooves which cross to form an “X” are provided—particularly preferably—e.g., in the manner of two crossing crescents. The axis of rotation of the swivel motion is positioned eccentrically relative to a device central axis. Particularly preferably, the guide grooves extend diagonally across the base element. The guide grooves preferably have a radius of curvature that nearly corresponds to a swivel radius of the coupling around one of the pegs as the rotation point.

In a starting position, the pegs of the rod holder are inserted into the upper, spread-apart ends of the X-shaped guide grooves in the base element. During the swiveling motion, the tool holder and the rod holder can be laterally rotated or swiveled via the coupling at an angle of at least 45° relative to each other around a device central axis by guiding the coupling with one of the guide grooves in the base element along one of the pegs, while the other peg defines an axis of rotation. The swivel motion can be initiated from the outside via an application of force.

Particularly preferably, the swiveling can take place laterally in one direction and in the opposite direction; an end position is advantageously rotatable by +/−90° relative to the starting position. It is particularly advantageous that the tool located in the swiveled tool holder can be actuated at a right angle to the starting working position. This is advantageous when trimming the edges of a lawn or the like. The pivotable unit can also be swiveled into any intermediate position, as needed.

In a particularly preferred refinement, the coupling includes a plate-shaped locking element with a second swivel guide, which is incongruent with the swivel guide of the base element, over at least a portion of the area. Preferably, the swivel guide can also be designed as a guide groove, and particularly preferably as two guide grooves which cross to form an “X”, and which are incongruent with the guide grooves of the base element, at least over a portion of the area. In particular, the ends of the guide grooves can be designed such that locking means are provided for locking in an end position; the pegs snap into the guide grooves when one of the end positions is reached.

When swiveling back to the starting position, it is favorable that an initial resistance need be overcome, thereby resulting in a particularly preferred locking element. After the initial resistance is overcome, the pivotable unit can be swiveled in a defined manner once more using the pegs and guide grooves until another desired position is reached, e.g., the starting position. A spring element can be provided to offset relative motions between the base element and the locking element or the coupling and the tool holder.

In a particularly preferred variant, the rod holder includes connecting devices for detachably connecting wheels. The wheels can simply be clipped to the rod holder, for example, thereby greatly increasing operator comfort. It is particularly advantageous that the power tool can be guided on wheels, and that the tool holder can be swiveled simultaneously, while the wheels remain horizontal. In this case, in the working state, the device central axis is located parallel to the working surface.

If the swiveled unit is located in one of the end positions, i.e., swiveled by +/−90°, the tool is located in the tool holder such that the wheels can run on the working surface, e.g., the lawn, at least partially. Particularly preferably, a diameter of the wheels is designed such that, although the wheels are located close to the swiveled tool, they are advantageously not prevented from rolling. Favorably, the guide rod does not come in contact with the wheels in the starting position or when swiveled into the end position.

Overall, with the proposed solution, a power tool equipped with a pivotable unit is provided that is characterized by the fact that it is particularly user-friendly.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a view of a preferred embodiment of an inventive hand-guided power tool, in an exploded view;

FIG. 2 shows a perspective view of the power tool in the assembled state with a guide rod, in a starting position;

FIGS. 3a, b, c show a front view of a preferred embodiment of a coupling in a neutral starting position (FIG. 3a), in an end position in which it is swiveled by 90° relative to a guide rod holder, in one direction (FIG. 3b) and in another direction (FIG. 3c); and

FIGS. 4a, b show a depiction of a preferred embodiment of inventive hand-guided grass clippers from above, in a starting position (FIG. 4a), and swiveled into an end position (FIG. 4b).

### DESCRIPTION OF THE PREFERRED EMBODIMENTS

Identical elements in the figures are labeled with the same reference numerals.

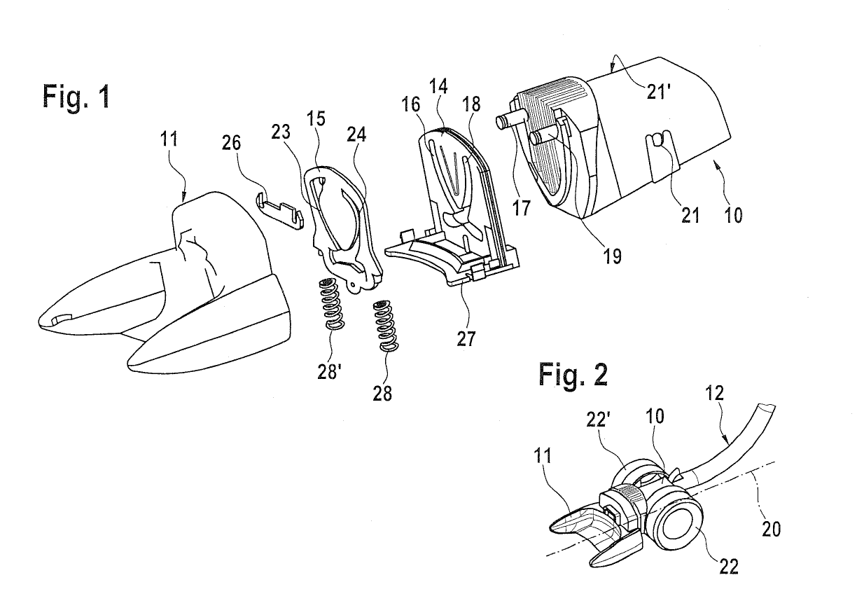

FIG. 1 is an exploded view of an embodiment of an inventive, hand-guided power tool designed as grass clippers with a rod holder 10 and a forked tool holder 11. A guide rod 12—which is not shown in FIG. 1—can be connected with rod holder 10. A not-shown tool, e.g., a cutting tool, can be clamped or snapped into tool holder 11.

A coupling is located between tool holder 11 and rod holder 10. According to the present invention, the coupling includes a swivel guide that makes it possible for tool holder 11 and rod holder 10 to rotate relative to each other. The coupling is connected with tool holder 11 using a fastening element 26 such that a unit is formed that is capable of swiveling relative to rod holder 10.

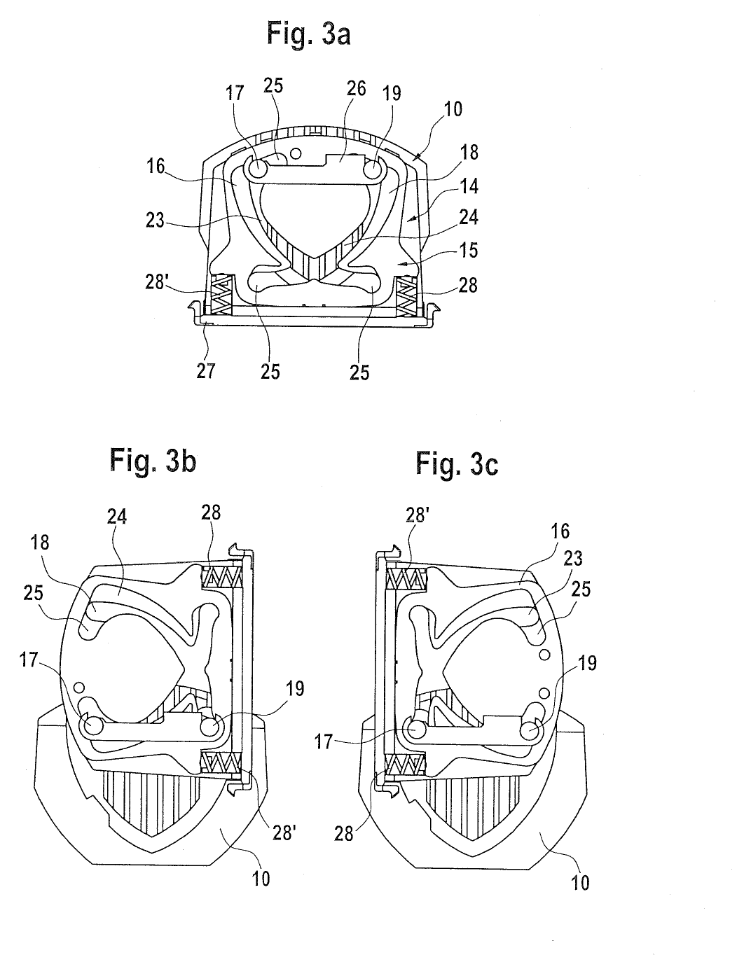

The coupling includes an essentially plate-shaped base element 14 and a locking element 15. Each of the elements 14, 15 includes a swivel guide. With plate-shaped base element 14, two guide grooves 16, 18, which cross to form an “X”, are provided as the swivel guide; guide grooves 16, 18 are engaged with two corresponding pegs 17, 19 of rod holder 10. Pegs 17, 19 extend axially away from the end face of rod holder 10 and engage in the coupling. The swivel mechanism is explained in detail with reference to FIG. 3.

In the installed state, locking element 15 is located on the tool holder-side of base element 14 and is connected—together with base element 14—with tool holder 11 via fastening element 26. Locking element 15 includes a second swivel guide composed of two guide grooves 23, 24, which is incongruent with the swivel guide of base element 14, over at least a portion of the area.

The fastening element includes two recesses which correspond with pegs 17, 19. In the connected state, rod holder 10, sub-elements 14, 15 of the coupling, and tool holder 11 are adjacent and aligned with each other around the circumference. Base element 14 includes a flat projection 27 on the lower edge, which serves as a cover in the installed state. In the installed state, two spring elements 28, 28′ are located in two recesses in base element 14, which extend vertically relative to the working surface and which extend laterally.

Rod holder 10 includes two connecting devices 21, 21′ on the sides for detachably connecting wheels 22, 22′, as shown in FIG. 2. FIG. 2 shows the power tool in the installed state, with a guide rod 12 located on the free end of rod holder 10. Guide rod 12 can also be designed as a telescoping rod, so that the length can be adjusted in a flexible manner. The depiction in FIG. 2 shows the power tool in a non-swiveled starting position of tool holder 11. In the working state, a device central axis 20 is located parallel to the working surface.

FIG. 3 shows a front view of a preferred embodiment of a coupling of a power tool. FIG. 3a shows a neutral starting position. FIGS. 3b and 3c show an end position in which the coupling is swiveled by 90° relative to a guide rod holder, in one direction, and in the opposite direction.

In FIG. 3a, fastening element 26, locking element 15, base element 14, and rod holder 10 are located one behind the other in the plane of the illustration, and they are connected via pegs 17, 19. It is clear that the swivel guide of locking element 15 designed as guide grooves 23, 24 is incongruent with the swivel guide of base element 14 designed as guide grooves 16, 18, over at least a portion of the area. Guide grooves 16 and 18, and 23 and 24, cross each other and form an “X”; the point of intersection is displaced downward, in the direction toward projection 27, relative to device central axis 20. Guide grooves 16 and 18, and 23 and 24, are curved outwardly; their radius of curvature corresponds approximately to a swivel radius of the pivotable unit around one of the pegs 17, 19. In the top view, guide grooves 16 and 18, and 23 and 24, are designed as two crossing sabers.

In the starting position, pegs 17, 19 engage in the upper, spread-apart ends of X-shaped guide grooves 16, 18, 23, 24. The pivotable unit, which is composed at least of base element 14, locking element 15, and not-shown tool holder 11, is capable of being swiveled laterally relative to rod holder 10.

The swivel motion to the right (FIG. 3b) is designed such that peg 17 forms an axis of rotation, and the pivotable unit is guided along guide grooves 18, 24 such that guide grooves 18, 24 run along peg 19. The axis of rotation of the swivel motion is positioned eccentrically relative to device central axis 20. Detent elements 25 are created using bulges formed on the outer ends of guide grooves 23, 24 of locking element 15. As soon as the pivotable unit has reached an end position, when swiveling, that is displaced by 90° relative to rod holder 10, the pivotable unit snaps into place. When it swivels back, initial resistance must be overcome in order to swivel the pivotable unit out of the end position back in the direction toward the starting position.

The rotation in the opposite direction (FIG. 3c) takes place in a similar manner; the swivel motion can be guided along peg 17 in guide grooves 16, 23, and it can be swiveled around the other peg 19 as the axis of rotation. Relative motions between base element 14 and locking element 15 are compensated using spring elements 28, 28′. During assembly, base element 14 and locking element 15 can be preloaded relative to each other using spring elements 28, 28′. Pivot pegs 17, 19 remain in their positions when the swivel motions take place.

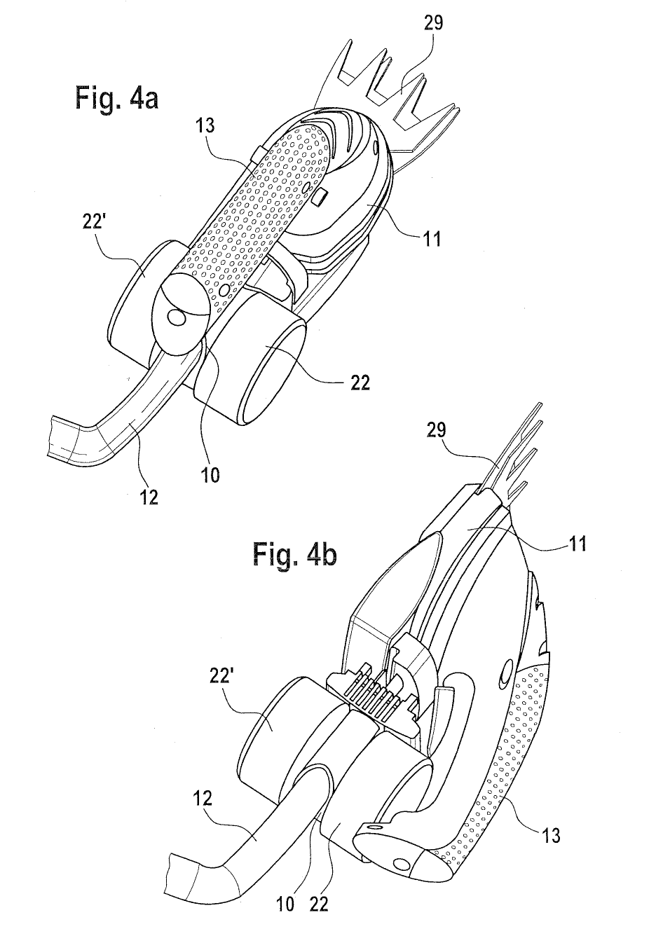

FIG. 4 is a perspective illustration of an alternative, particularly preferred embodiment of hand-guided power tool in the form of grass clippers. Grass clippers include a rod holder 10, with which a guide rod 12 is connected, and which includes connecting devices that cannot be seen from the side, and via which wheels 22, 22′ are clipped on. A not-shown drive unit and transmission unit are located in a device body 13. Device body 13 is designed as a handle bar on its housing surface, thereby making it easier to manually initiate the swivel motion. The grass clippers are shown in a starting position in FIG. 4a. FIG. 4b shows the pivotable unit swiveled into an end position at the right, with the swivel motion being carried out as described above.

A diameter and width of wheels 22, 22′ are dimensioned such that, when the pivotable unit has been swiveled into the end position, wheels 22, 22′ can run freely on the working surface. A cutting tool 29 of the grass clippers is positioned vertically to the working surface when in the swiveled state, thereby making it possible to trim the edges of a lawn. Cutting tool 29 is located inside a wheel axis, so that wheels 22, 22′ can run, at least partially, while cutting tool 29 trims corners/edges of the lawn. Wheels 22, 22′ are located close to cutting tool 29. Guide rod 12 is connected with rod holder 10 such that it does not come in contact with wheels 22, 22′, either in the starting position or after it has been swiveled into the end position.

It will be understood that each of the elements described above, or two or more together, may also find a useful application in other types of constructions differing from the type described above.

While the invention has been illustrated and described as embodied in a hand-guided power tool and coupling of a hand-guided power tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A hand-guided power tool, comprising at least one rod holder; a tool holder; at least one guide rod connected with said rod holder; and a coupling located between said tool holder and said rod holder, said coupling having a swivel guide that permits said tool holder and said rod holder to rotate relative to each other.

2. A hand-guided power tool as defined in claim 1, wherein said coupling is composed of at least one plate-shaped base element.

3. A hand-guided power tool as defined in claim 1, wherein said swivel guide is configured with at least one guide groove, said rod holder having a peg which engages in said at least one guide groove.

4. A hand-guided power tool as defined in claim 1, wherein said rod holder includes two axially extending pegs which engage in said coupling, one of said pegs being guided in a guide groove, while said tool holder connected with said coupling is pivotal around the other of said pegs as an axis of rotation.

5. A hand-guided power tool as defined in claim 1, wherein said swivel guide has two longitudinal guide grooves which cross and form an “X”

6. A hand-guided power tool as defined in claim 1, wherein said swivel guide is configured to permit a swivel motion having an axis of rotation which is located eccentrically relative to a central axis of the hand-guided power tool.

7. A hand-guided power tool as defined in claim 1, wherein said tool holder and said rod holder are swivelable laterally via said coupling at an angle of at least 45° relative to each other and around a central axis of the hand-guided power tool.

8. A hand-guided power tool as defined in claim 1, wherein said coupling includes a plate-shaped locking element with a second swivel guide which is incongruent with a swivel guide of a base element, over at least a portion of an area.

9. A hand-guided power tool as defined in claim 1, wherein said rod holder includes connecting devices for a detachable connection of wheels.

10. A coupling of a hand-guided power tool, comprising at least one base element; at least one locking element, wherein each of said at least one base element and said at least one locking element includes at least one groove.

11. A coupling as defined in claim 10, wherein said guide groove of said locking element is incongruent with said guide groove of said base element over at least a portion of an area.

12. A coupling as defined in claim 10, wherein said locking element includes at least one detent element for locking in an end position.

13. A coupling as defined in claim 10, further comprising means for forming two guide grooves.
